(19) United States
(12) Patent Application Publication
(10) Pub. No.: US 2013/0300205 A1
(43) Pub. Date: Nov. 14, 2013

(54) METHOD AND APPARATUS FOR 3D ORIENTATION-FREE WIRELESS POWER TRANSFER

(71) Applicant: SAMSUNG ELECTRONICS CO., LTD., Gyeonggi-do (KR)

(72) Inventors: Ioannis Tzanidis, Plano, TX (US); Sridhar Rajagopal, Plano, TX (US); Farshid Aryanfar, Allen, TX (US)

(73) Assignee: SAMSUNG ELECTRONICS CO., LTD., Gyeonggi-do (KR)

(21) Appl. No.: 13/833,856

(22) Filed: Mar. 15, 2013

Related U.S. Application Data
(60) Provisional application No. 61/644,943, filed on May 9, 2012.

(51) Int. Cl. H04B 5/00

(52) U.S. Cl. CPC H04B 5/0037
USPC 307/104

(57) ABSTRACT

A transmit resonator includes at least two loop resonators, disposed in such that the magnetic field produced by each in the near-field zone is substantially orthogonal to that produced by the other at a certain or specific portion of the zone, a power divider configured to split a signal into at least two sub-signals with weighting coefficients, a delay array configured to delay the at least one of the sub-signals and feed each of the sub-signals to each of the loop resonators, and a controller to configure the delay array to control the polarization of the near zone magnetic field. A communication module to receive feedback information from a receiver, to determine the phases of at least two sub-signals to generate a near zone magnetic field optimized for the receiver.

This application incorporates by reference the content of U.S. Provisional Patent Application Ser. No. 61/644, 943, filed May 9, 2012, entitled “METHOD AND APPARATUS FOR ENABLING ORIENTATION FREE WIRELESS POWER TRANSFER.” The content of the above-identified patent documents is incorporated herein by reference.

### TECHNICAL FIELD

The present disclosure relates to wireless power transfer systems using magnetic resonance.

### BACKGROUND

Wireless power transfer, also referred to as wireless energy transfer or wireless charging, to electronic devices is becoming a global standard. The benefits of wireless power transfer (WPT) compared to wired power transfer can be summarized as follows:

Convenience: Users should not need to carry multiple wired chargers with them to charge devices such as laptops, mobile phones, tablets, notebooks, and the like. Instead, a wireless charger can be placed in areas such as conference rooms, coffee shop tables, airport waiting areas, at home, and so forth, and users can charge their electronic devices by simply placing the device close to a wireless charger, without having to use a wired connection. Standardization of the WPT systems will allow for charging of multiple devices, possibly of different make and model, from the same wireless charger, leading to a universal charging standard.

Practicality: The number of physical power outlets available in areas such as conference rooms, coffee shops, airport waiting areas, and the like is limited, thus restricting the number of users that have access to them. A wireless power transfer system overcomes this issue and offers fast and easy charging to multiple users simultaneously.

Transparency: Wireless power can penetrate various objects such as wood, plastic, paper and cloth, making power transfer possible to locations where physical wire access is either not recommended or impossible, such as implant devices, under water, moving while charging, and the like.

Green: Wireless power transfer is in accordance with the Universal Charging Solution (UCS) proposed by the International Telecommunication Union, a United Nations branch. In essence, UCS recommends the same charger to be used for all future handsets, regardless of make and model, yielding a 50 percent reduction in standby energy consumption, elimination of 51,000 tons of redundant chargers, and a subsequent reduction of 13.6 million tons in greenhouse gas emissions each year (source: the website of International Telecommunication Union).

### SUMMARY

An apparatus is provided. The apparatus includes a transmit resonator including at least two loop resonators that generate a magnetic field in the near-field zone (non-radiative), the at least two loop resonators being disposed in such that the magnetic field produced by each is substantially orthogonal to that produced by the other at a certain or specific portion of the zone. Specifically, the at least two loop resonators are oriented substantially perpendicular to each other. The apparatus also includes a power divider configured to split a signal into at least two sub-signals fed to the at least two resonators with amplitude weighting coefficients.

Another apparatus is provided. The apparatus includes a receiver resonator including at least two loop resonators capable of resonating in the presence of an external non-radiative magnetic field, the at least two loop resonators being disposed in such that the magnetic field received by each is substantially orthogonal to that received by the other. Specifically, the at least two loop resonators are oriented substantially perpendicular to each other. A power combiner is configured to combine sub-signals received from the at least two loop resonators.

A method is provided. The method includes controlling the polarization of a magnetic field in the near-field zone, by shifting phases of the signals in at least one of the two loop resonators, in order to optimize the received power with respect to polarization of the generated magnetic field in the near-field zone. The method further includes combining sub-signals generated from the at least two loop resonators.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate mutual inductance between two loops as a function of the angle of rotation, φ, of the Rx loop around its center;

FIG. 2 illustrates a block diagram for the wireless power transmission system according to embodiments of the present disclosure;

FIG. 3 illustrates a transmitter and a receiver operating under the linear polarization mode according to embodiments of the present disclosure;

FIG. 4 depicts how the linearly polarized magnetic field oscillates with time on a straight line but at different orientations depending on the location in the space around the resonator;

FIG. 5 illustrates a transmitter and a receiver operating under the elliptical polarization mode according to embodiments of the present disclosure;

FIG. 6 depicts the ellipse traced by the tip of the field vector at a fixed location in space, say r=r0, in the elliptical polarization mode according to embodiments of the present disclosure;

FIG. 7 illustrates a resonator array according to embodiments of the present disclosure;

FIG. 8 illustrates exemplary phase shift circuits for time delay excitation according to embodiments of the present disclosure;

FIG. 9 illustrates a wireless transfer system using a transmit and receive resonators according to embodiment of the present disclosure; and

FIG. 10 depicts the mutual inductance M of the system of resonators with and without the use of phase shifters according to embodiments of the present disclosure.

### DETAILED DESCRIPTION

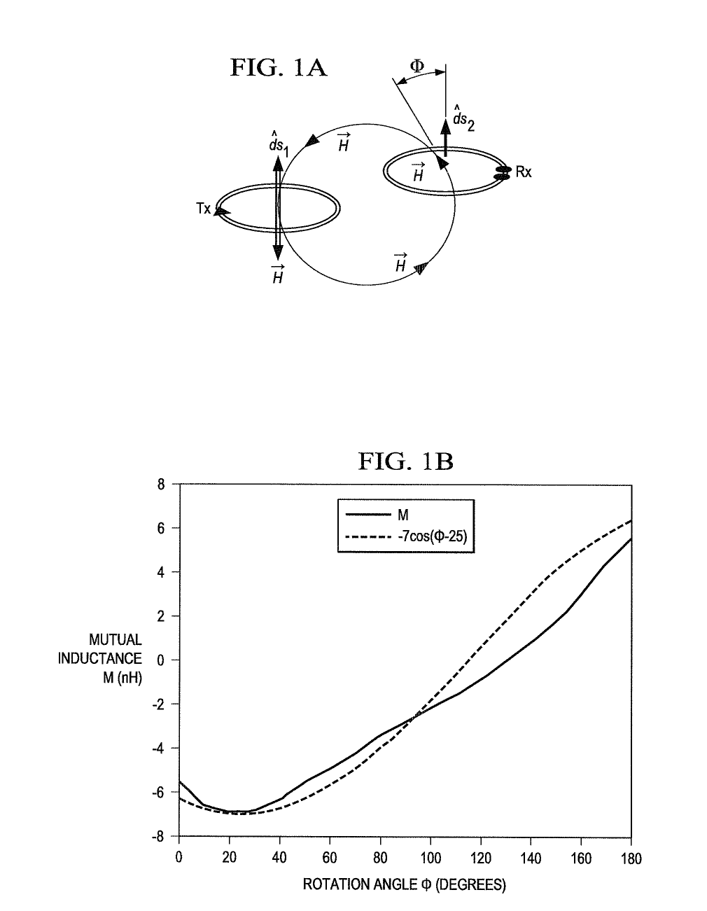

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless power transfer system.

### Inductive and Capacitive Coupling Techniques

U.S. Pat. No. 2,133,494 issued to Water introduced inductive coupling technique for wireless power transfer, where based on Faraday's and Ampere's laws, energy was transferred via mutual induction between two planar or 3D coils, one placed at the transmitting device and the other at the receiving device. This technique has been widely used ever since in house appliances, such as cooking utensils, water heaters, electric toothbrushes, table lamps, and more recently for charging cell phones. See, for example, U.S. patent application Ser. No. 12/472,337 naming Randall, et al. as the inventors. Although wireless in nature, inductive coupling is only efficient at trivial distances (less than a few mm), which for most applications implies direct contact of the transmitter and receiver devices. Another drawback of inductive coupling is that it requires a very precise alignment between the coils of the transmitter and the receiver devices, assisted in some cases by magnets. To address this issue, U.S. Pat. No. 7,952,322 to Partovi, et al. demonstrates a technique where the transmitter surface is divided up into many small coils that can be selectively switched on and off, depending on the receiver's position on the pad, thus providing an effectively larger charging area with more uniform magnetic flux than that of a single coil that covers the same physical area. Instead of inductive coupling, power transfer can be achieved by means of capacitive coupling. See, for example, U.S. patent application Ser. No. 12/245,460 naming Bonin as an inventor.

### Resonant Coupling Techniques

In 2007, Karalis et al. (“Efficient wireless non-radiative mid-range energy transfer”, Ann. Physics, 2007), demonstrated another wireless power transfer technique, referred to as “non-radiative midrange energy transfer”, which enabled power transfer to distances ranging from a few centimeters to a few meters. This technique was based on resonant coupling, described by the coupled mode theory (Haus et al., “Coupled mode theory”, 1991). Resonant coupling works in principle as follows: two objects placed at each other's near-field (non-radiative field) tend to couple energy to each other efficiently if their resonance frequency is the same, but inefficiently if their resonance frequency is not the same. A key feature of resonant coupling is that high coupling efficiency is associated with resonators with high quality factors. U.S. patent application Ser. No. 12/789,611 naming Campanella et al. as the inventors shows a generic example of two coupled resonators, separated by distance D. The first resonator designated as source is connected to a power supply, and the second resonator is connected to a load designated as device, which consumes or stores the power coupled to it by the source. An example of two such resonators is the ring shaped resonators as shown in FIG. 8 of U.S. patent application Ser. No. 12/789,611.

The operation principle of resonant coupling implies the following:

1) Energy is exchanged not by radiation, but by the non-radiative reactive near field. Thus, the resonating objects are placed within each other's near field zone. This implies that the operating wavelength is much larger than the physical sizes of the resonators, i.e. the resonators are electrically small objects.

2) Electrically small objects behave generally either as inductors (small loops) or capacitors (small dipoles), and are inherently non-resonant, unless they are forced to resonate by means of adding a capacitance or inductance, respectively, in series or in parallel to their terminals. In the case of inductive resonators, coupling occurs via mutual inductance, whereas in the case of capacitive resonators, coupling occurs via mutual capacitance. An example of inductively coupled resonators is described in U.S. Pat. No. 7,825,543 to Karalis et al. Coupling occurs via mutual inductance M between inductors Ls and Ld, while the capacitors Cs and Cd are used to resonate the structure at the desired frequency.

3) Coupling efficiency is proportional to the quality factor Q of the resonators. The quality factor of a resonator is defined as the ratio of its reactance (capability to store energy in the near field) over its resistance (dissipated energy or loss). In electrically small objects, resistance is mainly due to dielectric or Ohmic losses, and less due to radiation loss, which is generally negligible. Efficient wireless power transfer requires high Q resonators, and as such is susceptible to even small amounts of loss. To reduce the amount of loss, a technique was recently proposed based on using superconducting materials and low loss dielectric-less capacitors. See, for example, U.S. patent application Ser. No. 13/151,020 naming Sedwick as the inventor.

### Improving Efficiency in Mutual Coupling

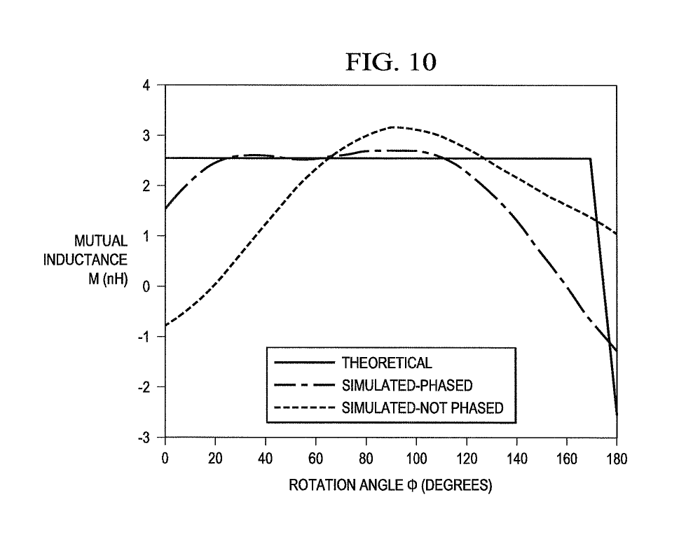

As mentioned above, coupling efficiency is maximized at the resonance frequency of the employed resonators. This frequency is determined by the size and shape of the resonators, which can be precisely tuned by a capacitor (or inductor in case of capacitive mutual resonant coupling) connected in series or in parallel to their terminals. The value of this tuning element is a function of the desired resonance frequency and also the equivalent electrical parameters (R, L, C and M) of the coupled resonators. Referring now to FIG. 10 of U.S. Pat. No. 7,825,543 to Karalis et al., for example, source-side capacitance Cₛ and drain-side capacitance C_{d} would be determined by source-side inductance Lₛ, drain-side inductance L_{d}, and the desired resonance frequency. Further, the parameters Lₛ, L_{d} and M are a function of the resonators shape, size and most importantly the relative position of the involved resonators.

In various practical applications, such as cell phone charging, the receiver device can change position during charging, causing the circuit parameters Lₛ, L_{d} and primarily M to change accordingly. Although Lₛ, L_{d} are affected little by motion or rotation of the receiver resonator, mutual inductance M changes significantly, leading to frequency detuning and dramatic drop in the power transfer efficiency. This is one of the biggest challenges of the resonant coupling technique.

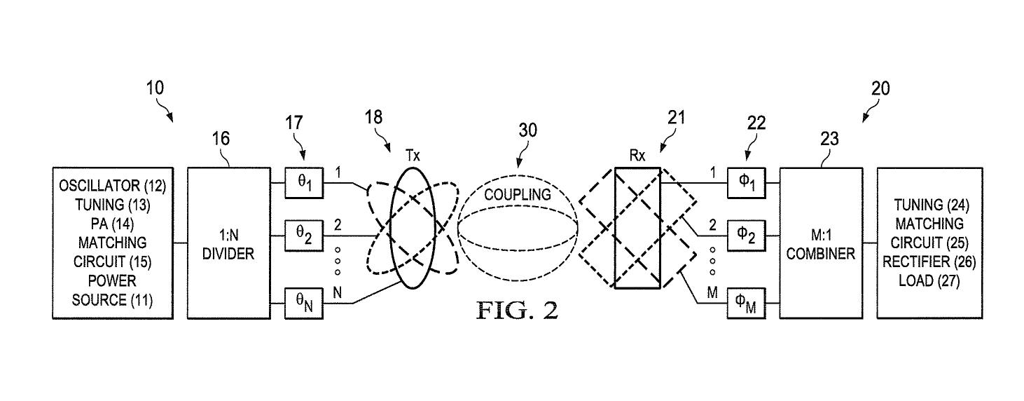

U.S. patent application Ser. No. 12/789,611 naming to Gampanellar as the inventors introduces an adaptive matching network as a solution to the detuning problem. As shown in FIG. 2 of the application, changes in mutual inductance M detune the resonance frequency, which is re-tuned by a variable capacitor C₁. However, depending on the use case, implementing an adaptive tuning network can increase the system complexity and cost significantly. Often, to ensure fast and efficient tuning of the coupled resonators, the transmitter and receiver communicate via a wireless channel (e.g., Zigbee). This configuration is referred to as “closed loop”, vs. the “open loop” where the transmitter or receiver has to find the optimum tuning setting independently, for example by minimizing some metric such as the VSWR on their feed lines as described in U.S. patent application Ser. No. 12/266,522 naming Toncich as the inventor.

Changes in the coupling condition that lead to detuning occur not only when one of the resonators changes position. In a scenario of multiple resonators, when resonators are added to or removed from the wireless charging network, detuning may occur. In these cases, besides retuning, other considerations in the system level become very important for maintaining high efficiency, such as power distribution and management between multiple receivers (U.S. patent application Ser. Nos. 12/249,861 and 12/720,866). Further, to selectively transfer power to certain devices and prevent power transfer to unauthorized ones, a technique was proposed based on frequency hopping (U.S. patent application Ser. No. 12/651,005)

### Randomly Oriented Receivers and Longer Range Power Transfer

To increase the range of wireless power transfer, U.S. patent application Ser. Nos. 12/323,479 and 12/720,866 proposed a technique using intermediate resonators (referred to as repeaters) to transfer power to more distance resonators. In a room environment, this concept can be applied as shown in FIG. 12. A large loop (referred to as “long range room antenna”) enclosing the whole room is connected to a generator. To increase the efficiency of power transfer to multiple devices, the repeater loops P₁ and P₂ are employed.

Another technique for increasing the range of wireless power transfer is to use the so called “near field focusing” technique, introduced by R. Merlin (see, R. Merlin, “Radiationless Electromagnetic Interference Evanescent-Field Lenses and Perfect Focusing”, 10.1126/science.1143884) and A. Grbic (A. Grbic, “Near-field focusing plates and their design”, IEEE Trans. On Antennas and Propagation, Vol. 36, Issue 10, pp 3159-3165, 2008). Near-field focusing was proposed in U.S. patent application Ser. No. 12/978,553 naming Ryu et al. as the inventors via a metasuperstrate, MNZ/ENZ (p near zero/E near zero) material, or high impedance surface (HIS). The metasuperstrate is placed in front of the transmit resonator and can focus its near-field at the location of the receive resonator, with subwavelength accuracy.

A technique for transferring power to randomly oriented receivers is described in U.S. patent application Ser. No. 12/053,542 naming Ryu et al. as the inventors. Referring now to FIG. 4, the transmit resonator is mounted on a pillar or bar and vertically placed on a flat surface. The transmit resonator transfers energy wirelessly to the receive resonators embedded in the frames of the 3D glasses lying on the flat surface. Similarly, a technique based on using orthogonally placed resonators, such as loops, for charging power tools in metallic cabinets or portable tool cases is described in U.S. patent application Ser. No. 12/567,339 naming Ozaki et al. as the inventors. Orthogonal placement of the transmit resonators on the side walls and top/bottom of the cabinet or tool case, was claimed to provide for multi-dimensional wireless charging.

### Summary of Mutual Inductance Theory

Power transfer efficiency of wireless power transfer (WPT) systems depends strongly on the relative position and orientation of Transmitter (Tx) and Receiver (Rx) units, as well as the presence of adjacent objects, either participating in the WPT as repeaters, or not (i.e., extraneous objects) and multiple Rx units. This is because the mutual coupling measured by the mutual inductance M between Tx and Rx units changes significantly if the Rx or Tx units are moved or rotated with respect to each other. In theory, mutual inductance Mᵢⱼ between two loops i and j, is calculated generally by the following equation:

$${M}_{ij} = \frac{{Φ}_{i}}{{I}_{j}} = \frac{{\int }_{{S}_{i}} {\vec{B}}_{j} \cdot \vec{d} {s}_{i}}{{I}_{j }} = \frac{{V}_{i}}{{I}_{j}} \qquad ( 1 )$$

where, Mᵢⱼ is mutual inductance between two loops i and j, and Φᵢ is magnetic flux through loop i, and Iⱼ is current of loop j. The flux Φᵢ is due to the magnetic field intensity Bⱼ caused by the current Iⱼ of loop j.

Referring to FIG. 1A, where two loops i and j are of a small size with respect to the operating wavelength, and under the assumption of a uniform magnetic field Bⱼ produced by current Iⱼ at the location of loop i, the equation 1 can be simplified as follows:

$${M}_{ij} = \frac{{B}_{j} {A}_{i} cos φ}{{I}_{j}} \approx {M}_{0} cos φ \qquad ( 2 )$$

where, Aᵢ is the physical area of loop i and cos φ is the angle between the magnetic field vector Bⱼ and the surface normal of loop i.

FIG. 1B depicts a typical variation of mutual inductance M between two loops at a small size with respect to the operating wavelength, as a function of the angle of rotation, φ, of one loop around its center. The solid line comes from numerically simulated data. The dashed line is the cosine function (see, Equation 2) fitted to the simulated data. As seen, maximum mutual inductance of (−)7 nH occurs when the Rx loop is rotated to φ=25°. The minus sign shows that the induced voltage (electromotive force, EMF) to the Rx reverses polarity. This behavior is typical in wireless power transfer systems that employ transmit and receive resonators that are linearly polarized. Such fluctuations in mutual inductance cause the resonant coupling to detune and result in severe drops of the power transfer efficiency. As a result, the Tx unit becomes impedance mismatched, charging of the Rx unit slows down, or even stops and the Tx unit can suffer from overheating.

### Wireless Power Transmission System

FIG. 2 illustrates a block diagram for the wireless power transmission system according to the embodiments of the present disclosure. The wireless power transmission system includes a transmitter 10 and a receiver 20, and a near zone magnetic field 30 is formed between the transmitter 10 and the receiver 20. Energy is transferred from the transmitter to the receiver via the near magnetic field, which is maximized during matched or nearly matched resonance between the transmitter 10 and the receiver 20.

The transmitter can include a power source 11, an oscillator 12, a power amplifier 14, a matching circuit 15, a power divider 16, a delay array, and a transmit (Tx) resonator array 18. The delay array can be implemented by a phase shifter 17. The oscillator 12 generates a signal with a desired frequency that is amplified by the power amplifier 14. The power divider 16 splits the amplified signal into a number of “M” (#M) sub-signals with the weighing coefficients A₁, . . . , A_{M}.

The divided #M sub-signals are inputted to the delay array, which can be implemented by a phase shifter 17 that delays the sub-signals or shifts the #M sub-signals to have the phases θ₁, . . . , θ_{M} with respect to a reference. One of these phases can serve as the reference phase, i.e. zero, so that all other phases can be set with respect the reference phase. Finally, the Tx resonator array 18 is fed with #M sub-signals with the weighing coefficients A₁, . . . , A_{M} and the phases θ₁, . . . , θ_{M}. The phase shifter 17 can be designed as part of the feed network, but also structurally integrated with the resonators (e.g., with surface mount components).

The Tx resonator array 18 can include #M resonators configured such that each produces magnetic fields substantially orthogonal to the magnetic fields of the others. In one embodiment, #M resonators can be substantially orthogonal to one another. The i-th resonator of #M resonators is fed with the i-th sub-signal with the weighing coefficient Aᵢ and phase θᵢ. Then the i-th resonator resonates, producing the i-th polarized magnetic field corresponding to the fed i-th sub-signal. Finally, the first to M-th magnetic fields generated from #M resonators are combined, forming a magnetic near field. The matching circuit 15 matches the internal impedance of the power amplifier to the input impedance of the combined signal that goes into the Tx resonator array 18.

The term “substantially orthogonal” as herein to describe the direction of the magnetic fields, refers to the state that the direction of vectors of the magnetic fields generated by at least two loop resonators cross one another to generate a polarized magnetic field, such as an elliptically, circularly or linearly polarized magnetic field. The range of degrees between two magnetic field vector directions in order to be “substantially orthogonal” is from 15° to 165°.

In some embodiments, the transmitter 10 includes a communication module to receive feedback information from the receiver 20, and configures the delays or phases of the sub-signals of the transmitter 10 to configure the polarization of the generated near zone magnetic field 30 so that it is optimized for the receiver 20.

The receiver 20 resonates in the presence of the magnetic field 30 to receive power, and charges a battery or powers a device coupled to the receiver 10. To do this, the receiver 10 can include a receive (Rx) resonator array 21, a phase shifter 22, a power combiner 23, a rectifier 26 and a matching circuit 25.

The Rx resonator array 21 can be comprised of a number of “N” (#N) resonators that are tuned to have a resonance in presence of an external magnetic field. The sub-signals induced in each resonator are delayed appropriately (e.g., by changing their phase φ₁, . . . , φ_{N} by the phase shifter 22). The i-th resonator with phase φᵢ is resonated to a portion of the polarized magnetic field 30 and produces a coupling current from the resonance. A delay array such as a phase shifter can be designed as part of the feed network, but also structurally integrated with the resonators (e.g., surface mount components). As stated, phase shifter 22 provides each resonator with the appropriate time delay or phase at the transmitter 10 and receiver 20 respectively.

The power combiner 23 combines the unequally delayed AC currents created from the Rx resonator array 21 and the delay array. By appropriately choosing the sub-signal delays or phases the power of the combined AC signal can be maximized. This can be done in conjunction with optimizing the delays or phases of the sub-signals in the transmitter array. The rectifier 26 converts the combined AC current to the DC current which is stored or consumed by a device. The matching circuit matches the impedance of the combined signal of the receiver 20 to the impedance required by the rest of the RX resonator array 21 circuitry (i.e., rectifier, regulator) such that optimum charging conditions (current, voltage) are created at the charging device or load (such as a battery).

In some embodiments, the receiver 20 further includes a communication module to transmit feedback information so that the transmitter configures its phases to generate the near zone magnetic field optimized to the receiver.

The transmitter 10 and the receiver 20 stated above can be used together to maximize the efficiency of power transfer. However, the transmitter 10 can also be used with other types of receive resonators, such as a single receive resonator (#M=1). The receiver 20 also can be used with the other types of transmit resonators, such as a single transmit resonator (#N=1). In some embodiment, an intermediate loop resonator can be located between the transmitter 10 and receiver 20 to relay the near zone magnetic field at longer ranges.

### Linear Polarization Mode

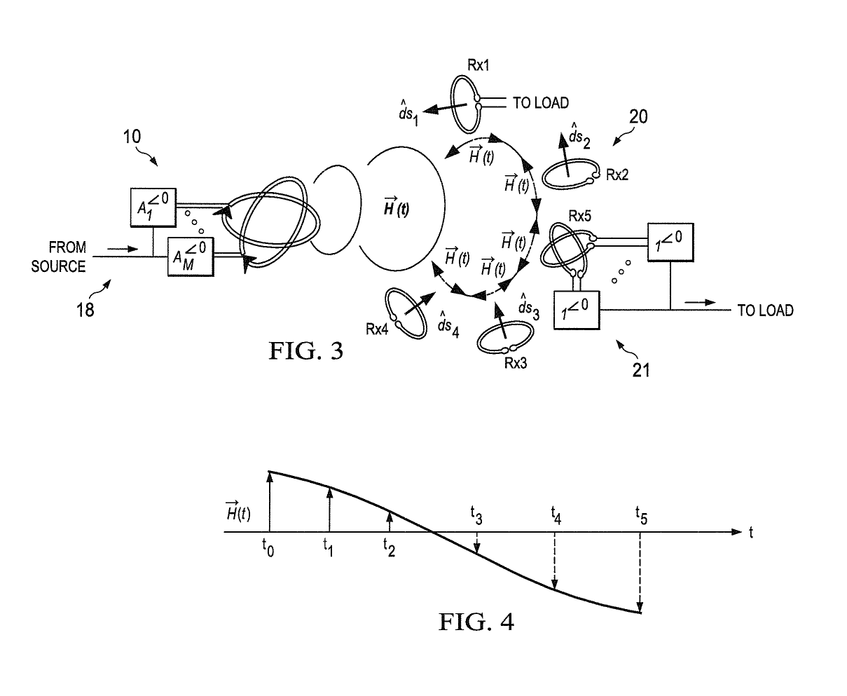

FIG. 3 schematically illustrates the transmitter 10 and the receiver 20 operating under the linear polarization mode according to one embodiment of the present disclosure. A linearly polarized transmitter 10 can be implemented either by a single resonator with one excitation port (one sub-signal), or a resonator array with multiple in-phase excitation ports (i.e., zero delay or phase difference between sub-signals).

In the case of a linearly polarized transmitter 10 comprised of a resonator array 18 with #M resonators, all resonators are transmitting in phase (i.e., zero phase difference between sub-signals), and power is able to or not to be uniformly distributed among the array elements, hence the excitation coefficients A₁ . . . A_{M}.

A linearly polarized transmitter 10 has no control of the phase of the current on the resonator structure, and produces equivalent linearly polarized magnetic fields. A linearly polarized field can be expressed over time at a fixed location in space, say r=r0 as follows:

\vec{H}(r=r₀,t)=\vec{H}₀ cos(ωt) (3)

FIG. 4 depicts how the magnetic field vector oscillates at a fixed location in space, say r=r0, and at different time instances. As seen, the vector oscillates on a straight line but at different orientations depending on the location around the resonator, as shown in FIG. 3.

A linearly polarized receive resonator 20 can have a single resonator with one excitation port, or a resonator array with multiple in-phase excitation ports. In the case that a linearly polarized receiver includes a resonator array with #M resonators, the phase difference between all resonators is set to zero (i.e., resonators are receiving in phase).

Referring back to FIG. 3, the resonators Rx₁ and Rx₂, where the magnetic field vector is parallel to the surface normal of resonators, are optimally oriented for maximum mutual coupling with a transmitter. As the Rx unit is rotated at an angle φ at a particular Rx location, away from the optimum orientation, the mutual coupling will drop proportionally to the cosine of the rotation angle T, causing detuning of the resonant coupling and drop in the coupling efficiency. As the worst case, resonators Rx₃ and Rx₄ where the surface normal of the Rx resonator is perpendicular to the magnetic field H at the location of the Rx, have zero coupling with a transmitter, thus do not receive any power.

In some embodiments, the resonator array Rx₅, still linearly polarized, can include multiple resonators, thus multiple ports, disposed at various orientations. Each resonator might or might not be favorably positioned depending on its orientation, and similar degradation in mutual coupling will occur with changes in orientation.

### Elliptical Polarization Mode

FIG. 5 schematically illustrates the transmitter 10 and the receiver 20 operating under the elliptically polarized mode according to one embodiment of the present disclosure.

In the embodiment, the transmitter 10 includes a Tx resonator array 18 comprised of #M resonators. Each Tx resonator produces a magnetic field corresponding to the sub-signal with the weighing coefficient Ai and the phase θi (i=1 . . . M). The magnetic fields generated from the #M resonators are combined to form the near zone magnetic field. The resonators of the resonator array 18 may or may not be electrically interconnected.

The transmitter 10 can control the polarization of near magnetic field by adjusting weighing coefficients A₁, . . . , A_{M} and the phases θ₁, . . . , θ_{M}. In other words, providing appropriate values of A₁, . . . , A_{M} and θ₁, . . . , θ_{M}, the near zone magnetic field H can be circularly or elliptically polarized, and thus rotate with time. Further, by forcing the near zone magnetic field \vec{H} to rotate, the transmitter enables power transfer via mutual inductance to the receivers for at least a portion of the cycle of rotation, independent of position or orientation around the Tx resonator.

An elliptically polarized magnetic field formed from two unit magnetic fields Hx, Hy can be expressed over time at a fixed location in space, say r=r₀ as follows:

\vec{H}(r=r₀,t)=\vec{H}ₓ cos(ωt+φₓ)+\vec{H}_{y} cos(ωt+φ_{y}) (4)

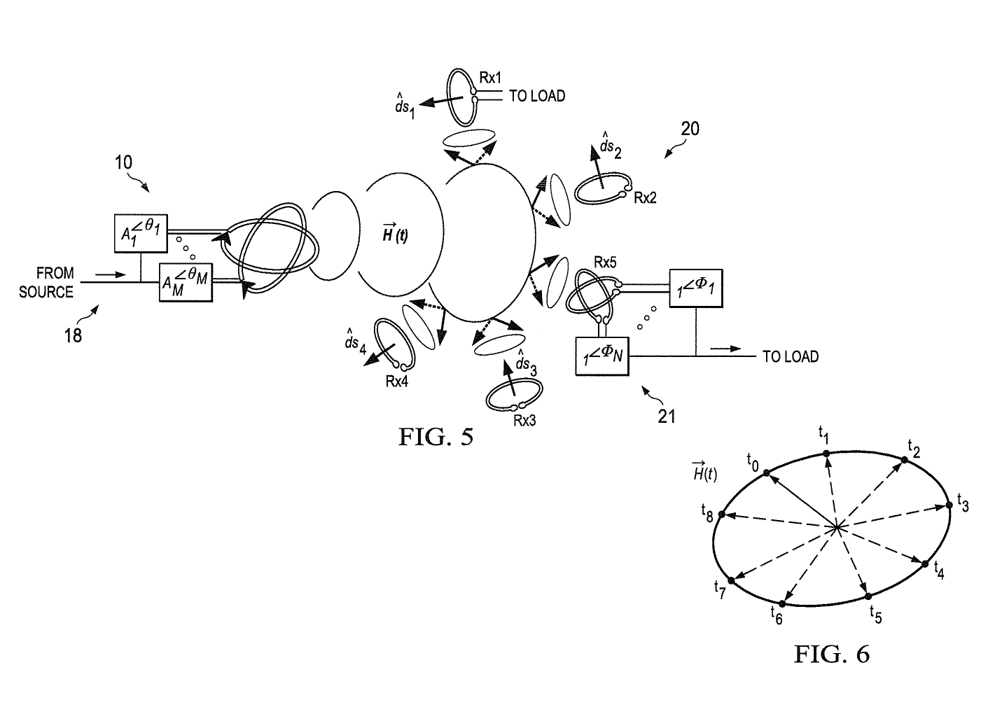

As shown in FIG. 6, at a fixed location in space, say r=r₀, the tip of the field vector traces an ellipse located on a specific plane. Depending on the magnitude and phase of the components Hₓ and H_{y}, polarization turns into circular, elliptical or linear. Specifically, the polarization of the near zone magnetic field becomes: circular when Hₓ and H_{y} are equal in magnitude and the phase difference between them is φₓ−φ_{y}=odd multiples of π/2; linear if the phase difference between them is φₓ−φ_{y}=multiples of π; and in all other cases elliptical. The phase shifts of each resonator can be predetermined or adjusted with respect to the shape of near zone magnetic field polarization. In some embodiments, the transmitter receives feedback information to configure the phases of each resonator so as to generate the near zone magnetic field optimized to the receiver.

It should be noted that x and y do not necessarily refer to the usual Cartesian coordinates, but rather to the exactly two perpendicular components \vec{H}ₓ and \vec{H}_{y}, necessary to express the polarization of any resonator at the near-field. Further, if the sub-signals fed into the multiple loop resonators have different resonance frequencies ω₁, ω₂, the polarization of the total magnetic field can be also controlled.

The receiver 20 under the elliptically polarized mode can include a single resonator, such as cases Rx₁ to Rx₄, or a resonator array 21, such as Rx₅, comprised of multiple resonators configured such that they can receive substantially perpendicular magnetic fields. In the case of the resonator array 21, the sub-signals received by the array resonators are delayed or phased with angles φ1 . . . , φn.

Referring back to FIG. 4, Rx resonators Rx₁ to Rx₄ are linearly polarized while resonator Rx₅ is elliptically polarized. Forcing the near zone magnetic field \vec{H} to rotate by appropriately adjusting the delay or phases of the Tx resonators, enables power transfer via mutual inductance to all receivers, independent of position or orientation around the Tx resonator. The Rx resonators can either be linearly polarized such as resonators Rx₁ to Rx₄, or elliptically polarized, such as Rx₅. All Rx₁ to Rx₄ receivers can be favorably positioned for some part of the cycle, and thus with proper design mutual inductance can stay at stable levels independent of the receiver resonator's orientation. In other embodiments, receiver Rx₅ can be designed to be circularly or elliptically polarized.

The phase shifts of each receive resonator can be predetermined with respect to polarization of the near zone field. Alternatively, using numerical optimization and circuit analysis, the required phase shifts can be found for each resonator so as to obtain stable mutual inductance M between the transmit and receive resonators, for a wide range of orientation angles.

In some embodiments, the receiver 20 transmits feedback information for the transmitter 10 to configure the phases of the transmit resonator array 18 so as to generate the near zone magnetic field optimized to the receiver.

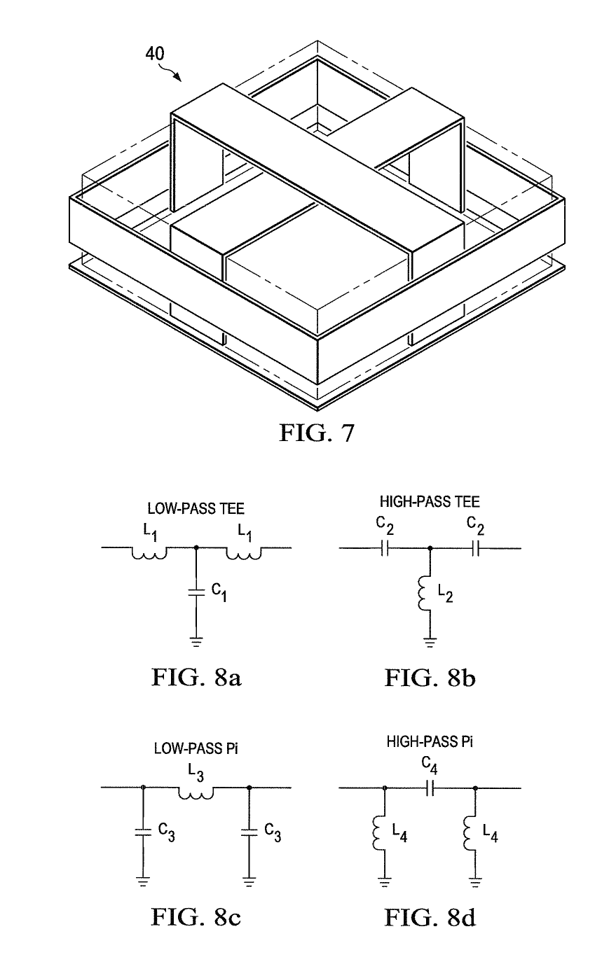

FIG. 7 illustrates an elliptically polarized resonator 40 array according to one embodiment of the present disclosure. As shown in FIG. 7, the resonator array includes three loop resonators, each resonator of which being substantially perpendicular to and overlaid on portions of one another. Accordingly, the three magnetic fields generated by three resonators are substantially orthogonal to one another in the near zone. The loops can be a number of different shapes (e.g., circular, elliptical, square, and rectangular). Also, the loops can be in wide variety of sizes. As stated above, each of three resonators is fed with sub-signal with a weighing coefficient Ai and a phase θi and produces magnetic fields corresponding to a fed sub-signal.

The term “substantially orthogonal” as herein to describe the placement of loop resonators refers to the state that the directions of the magnetic field vectors generated by at least two loop resonators cross one another to generate a polarized magnetic field, such as an elliptically, circularly or linearly polarized magnetic field. The range of degrees between two magnetic field vector directions in order to be “substantially orthogonal” is from 15° to 165°.

In some embodiments where the resonator array is adopted for a transmitter, the transmitter can be used to produce elliptically or linearly polarized magnetic field by adjusting weighing coefficients Ai and phases θi. In other embodiments, where the resonator array is adopted for a receiver, the receiver can maximize received power by adjusting the phases φi.

The resonant frequency of the loop resonator is based on the closed loop inductance and an externally added capacitance. Inductance in a loop resonator is generally the inductance created by the loop, whereas, capacitance is generally added externally to the loop resonator's inductance to create a resonant structure at a desired resonant frequency.

FIG. 8 illustrates exemplary phase shift circuits according to embodiments of the present disclosure. As stated above, the phase shifters are coupled to Tx and Rx resonators and provides each resonator with the appropriate phases θ₁, . . . , θ_{M}, and φ₁, . . . , φ_{N} to rotate the near zone magnetic field or to optimize Rx resonator to receive maximum power from that near zone magnetic field.

At low frequencies (i.e., the physical size and length of the resonator is much smaller than the operating wavelength) and for narrow bandwidths, such as that allocated for wireless power transfer, phase shifters can be implemented via low/high pass filters. The design of such filters can be guided using the lossless circuits and their corresponding equation as follows:

$$\begin{matrix}{L}_{1} = {Z}_{0} \frac{1 - cos ϕ}{ω sin ϕ} , {C}_{1} = \frac{sin ϕ}{ω {Z}_{0}} for ( a ) & ( 5 ) \\ {L}_{2} = \frac{{Z}_{0}}{ω sin ϕ} , {C}_{2} = \frac{sin ϕ}{ω {Z}_{0} ( 1 - cos ϕ )} for ( b ) & ( 6 ) \\ {L}_{3} = \frac{{Z}_{0} sin ϕ}{ω} , {C}_{3} = \frac{( 1 - cos ϕ )}{ω {Z}_{0} sin ϕ} for ( c ) & ( 7 ) \\ {L}_{4} = \frac{{Z}_{0} sin ϕ}{ω ( 1 - cos ϕ )} , {C}_{4} = \frac{1}{ω {Z}_{0} sin ϕ} for ( d ) & ( 8 )\end{matrix}$$

where, φ is the desired phase difference or delay at the specified frequency ω, and Z₀ is the characteristic impedance of the system.

The choice of the appropriate phase shifter topology is based on the availability of the components, the availability of space on the resonator device, the loss performance of the available components, and the like. In some embodiments, the phase shifter can be designed based on equations 5 to 8. Alternatively, an optimization method regarding the phase shift value can employed for best performance. Currently, standardization of wireless power transfer systems allows operation at the ISM frequency bands (6.78 MHz and 13.56 MHz with 15 KHz bandwidth). The choice of these frequencies relates to various reasons, however, from an electromagnetic standpoint there is no particular restriction in the choice of the operation frequency, as long as the near-field condition is satisfied.

### Demonstration of Orientation-Free Wireless Power Transfer

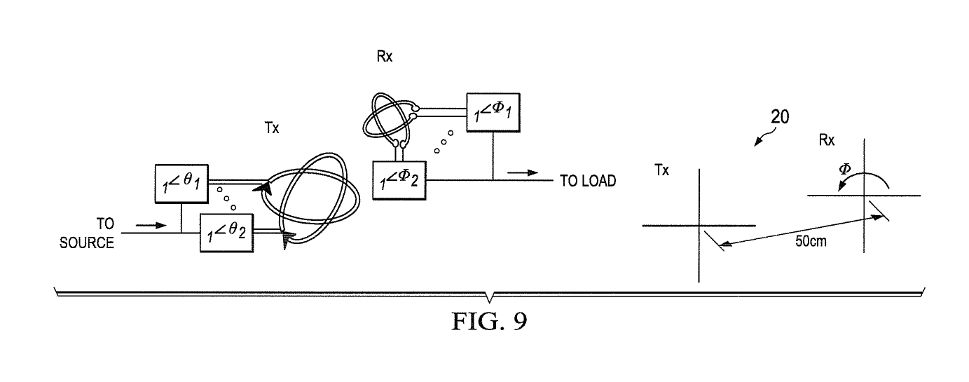

FIG. 9 illustrates a wireless transfer system using a transmit and receive resonators according to one embodiment of the present disclosure. The resonators include two orthogonally placed circular loops, 32 cm in diameter, and the two loops are fed with equal power via a T-junction. The receive resonator array is statically rotated around itself at angles φ [0°,180°] and the operation frequency is 6.78 MHz.

Using circuit analysis we found the required phase shift for each resonator so as to obtain stable mutual inductance M between the transmit and receive resonators, for a wide range of rotation angles. The equivalent circuit parameters for the Tx and Rx resonator are as follows:

L_{Tx}=69nH,L_{RX}=413nH,R_{Tx}=0.066Ω,R_{Rx}=0.052Ω (9)

Φ₁=180°,Φ₂=0°,θ₁=31°,θ₂=0° (10)

In the embodiment, the mutual inductance M of the system of resonators with and without the use of phase shifters is depicted in FIG. 10. As shown in FIG. 10, the use of phase shifters leads to a stable mutual inductance of 2.5 nH for rotation angles ranging from 20°-100°. On the contrary, if no phase shifters are used, mutual inductance exhibits large variations which lead to system detuning and loss of efficiency. It should be noted that the use of phase shifters at these low frequencies does not practically increase the system complexity or cost.

The embodiments of the present disclosure would provide methods and apparatuses that enable efficient wireless three dimensional (3D) power transfer independent of the relative position and orientation of a transmitter and a receiver.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus, comprising:
a transmit resonator array including at least two loop resonators configured to generate a non-radiative magnetic field in the near-field zone, the at least two loop resonators disposed such that the magnetic field produced by each in the near-field zone, is substantially orthogonal to that produced by the other at a certain or specific portion of the zone; and
a power divider configured to split a signal into at least two sub-signals being fed to the at least two loop resonators, with weighting coefficients.

2. The apparatus of claim 1, further comprising:
at least one phase shifter configured to shift phase of the at least one of the at least two sub-signals with respect to the phase of the other of the at least two sub-signals.

3. The apparatus of claim 2, further comprising:
a controller configured to control polarization of the near magnetic field by configuring the power divider and the at least one phase shifter, to adjust the weighing coefficients and the phases of each sub-signal, respectively.

4. The apparatus of claim 3, wherein the controller is configured to set weighting coefficients to be un-equal and set a phase difference between the at least two resonators to be neither an odd multiple of 90° nor an multiple of 180°, so that the near zone magnetic field is elliptically polarized in a specific portion of space surrounding the at least two loop resonators.

5. The apparatus of claim 3, where the controller is configured to set the weighting coefficients to be equal and phase difference between the at least two resonators to be odd multiple of 90°, so that the near zone magnetic field is circularly polarized in a specific portion of space surrounding the at least two loop resonators.

6. The apparatus of claim 3, where the controller is configured to set the weighting coefficients to be equal and the phase difference between the at least two resonators to be multiple of 180°, so that the near zone magnetic field is linearly polarized in a specific portion of space surrounding the at least two loop resonators.

7. The apparatus of claim 3, further comprising:
a communication module to receive feedback information from a receiver, to determine the amplitudes and the phases of at least two sub-signals to generate the near zone magnetic field optimized to the receiver.

8. The apparatus of claim 1, wherein the at least two loop resonators are either separated from one another or overlaid on portions of one another.

9. The apparatus of claim 1, further comprising:
an intermediate loop resonator configured to relay the near zone magnetic field at longer ranges.

10. An apparatus, comprising:
a receive resonator array including at least two loop resonators configured to resonate in the presence of an external non-radiative magnetic field, the at least two loop resonators being disposed in such that the magnetic field received by each is substantially orthogonal to that received by the other; and
a power combiner configured to combine sub-signals received from the at least two loop resonators.

11. The apparatus of claim 10, further comprising:
at least one phase shifter configured to shift phase of one of at least two sub-signals received by the at least two loop resonators, with respect to the other.

12. The apparatus of claim 10, further comprising a controller configured to adjust the phase shifts of the received sub-signals to optimize the combined reception of power by the at least two loop resonators.

13. The apparatus of claim 10, further comprising:
a communication module configured to transmit feedback information to a transmitter, to determine amplitudes and phases of the transmitter to optimize the near zone magnetic field.

14. The apparatus of claim 10, further comprising:
a controller configured to set a phase difference between the at least two resonators to be neither an odd multiple of 90° nor an multiple of 180°, so that the at least two loop resonators receive the sub-signals in an elliptically polarized near zone magnetic field.

15. The apparatus of claim 10, further comprising:
a controller configured to set a phase difference between the at least two sub-signals received from the at least two resonators to be an odd multiple of 90°, so that the at least two loop resonators are configured to optimally receive the sub-signals in a circularly polarized near zone magnetic field.

16. The apparatus of claim 10, further comprising:
a controller configured to set a phase difference between at least two sub-signals received from at least two loop resonators to be a multiple of 180°, so that the at least two loop resonators are configured to optimally receive in a linearly polarized near zone magnetic field.

17. The apparatus of claim 10, further comprising:
a converter configured to convert the combined signal to DC power and to output the converted DC power either to charge a battery or to power a device.

18. The apparatus of claim 10, wherein the at least two loop resonators are either separated from one another or overlaid on portions of one another.

19. The apparatus of claim 10, wherein the phase shifts of each sub-signal are predetermined with respect to the polarization of the near zone magnetic field.

20. A method, comprising:
generating, with at least two loop resonators, a non-radiative magnetic field in the near-field zone, the at least two loop resonators disposed in such that the magnetic field produced by each is substantially orthogonal to that produced by the other at a certain or specific portion of the zone;
shifting phases of the signals in the at least one of the two loop resonators in order to optimize the received power with respect to polarization of the near zone magnetic field; and
combining sub-signals generated from the at least two loop resonators.

21. The method of claim 20, further comprising:
transmitting feedback information to a transmitter to determine phases of the transmitter's sub-signals to generate the near zone magnetic field to be optimally received by a receiver.
